(19) United States
(12) Patent Application Publication
(10) Pub. No.: US 2014/0044624 A1
(43) Pub. Date: Feb. 13, 2014

(54) DETRITIATION DEVICE AND METHOD

(71) Applicants: Nicolas Ghirelli, Saint Maximin La Sainte Baume (FR); Pierre Trabuc, Venelles (FR); Olivier Gastaldi, Jouques (FR); Pascal Lejay, Grenoble (FR); Joel Balay, Grenoble (FR); Abdellali Hadj-Azzem, Villard-Bonnot (FR)

(72) Inventors: Nicolas Ghirelli, Saint Maximin La Sainte Baume (FR); Pierre Trabuc, Venelles (FR); Olivier Gastaldi, Jouques (FR); Pascal Lejay, Grenoble (FR); Joel Balay, Grenoble (FR); Abdellali Hadj-Azzem, Villard-Bonnot (FR)

(21) Appl. No.: 14/113,129

(22) PCT Filed: Apr. 23, 2012
(86) PCT No.: PCT/FR2012/050882

§ 371 Date: Oct. 21, 2013

(51) Int. Cl. G21F 9/30; G21F 9/00

(52) U.S. Cl. CPC G21F 9/308; G21F 9/007
USPC 423/210.5; 423/249; 422/159

(57) ABSTRACT

The invention relates to a detritiation device comprising i) a furnace (1) for melting tritiated waste, said furnace comprising a hearth for receiving tritiated waste and a bubbling device for introducing a hydrogenated bubbling gas into the hearth during the melting and treatment of the tritiated waste in the furnace (1), and ii) a catalytic reactor with a quadrupole membrane (2) for treating the gas resulting from the melting and treatment of the tritiated waste in the furnace (1), said reactor comprising a membrane (20) for separating two flows of gas, the membrane (20) being permeable to the hydrogen isotopes. The invention also relates to an associated detritiation method.

The present invention relates to a detritiation device and process. The present invention relates particularly to a detritiation device and process by bubbling fusible metallic radioactive wastes.

Detritiation is a heat and/or chemical treatment with the objective of extracting tritium trapped in the radioactive waste matrix, particularly fusible metallic radioactive wastes. The radioactive wastes that may need to be detritiated are those originating from nuclear facilities making use of tritium.

Detritiation of fusible metallic radioactive wastes strongly reduces their radioactivity, so as to simplify their subsequent storage, particularly due to the significant reduced requirements for protection of the environment and persons.

However, detritiation processes according to prior art produce large quantities of strongly tritiated water (HTO), for which management is complex.

One purpose of the present invention is therefore to disclose an advanced detritiation process and device capable of strongly reducing or even completely preventing the production of tritiated water at the end of this process.

This purpose is achieved particularly by a detritiation device comprising:
i) a furnace for melting tritiated wastes comprising:
   a crucible for receiving the tritiated wastes;
   a bubbling device for introducing a hydrogenated bubbling gas into the crucible during the melting and treatment of the tritiated wastes in the furnace; and
ii) a catalytic four-pole membrane reactor for the treatment of the gases originating from the melting and treatment of the tritiated wastes in the furnace, comprising a membrane to separate two gas flows, the membrane being permeable to isotopes of hydrogen.

This purpose is also achieved by a detritiation process comprising the steps of:
loading a crucible furnace with a batch of tritiated wastes;
heating the furnace to melt the tritiated wastes in the crucible;
bubbling the melting tritiated wastes by introducing a hydrogenated bubbling gas into the crucible;
circulating a vector gas between the furnace and a catalytic membrane reactor for entrainment of the tritiated gases produced during the melting and treatment of the tritiated wastes, and the treatment of the tritiated gases that comprises an isotopic exchange through the membrane of the catalytic membrane reactor.

Hydrogen isotopes are obtained at the end of this isotopic exchange, thus strongly reducing or completely preventing the production of tritiated water at the end of the detritiation process of the invention.

The combination of the crucible furnace and the membrane reactor results in an efficient detritiation process that produces almost no tritiated water at the end the process. Indeed, the melting and bubbling of the wastes in the crucible enables efficient and almost complete evacuation of tritium in gas form, and the gases such loaded are immediately treated in a membrane reactor that enables the tritium to be recovered also in the form of a gas mix, that is then easier to treat and/or store than tritiated water.

The present invention will be better understood after reading the following description illustrated by the figures where:

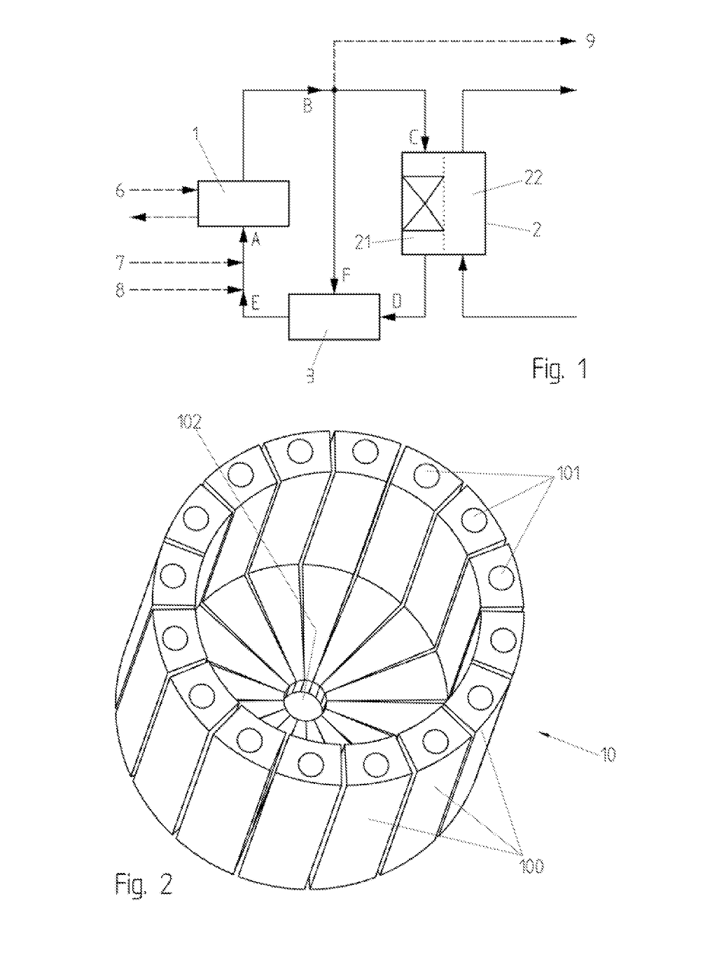

FIG. 1 is a principle diagram showing the detritiation process according to a preferred embodiment of the invention,

FIG. 2 is a detail of a cold crucible according to one embodiment of the invention,

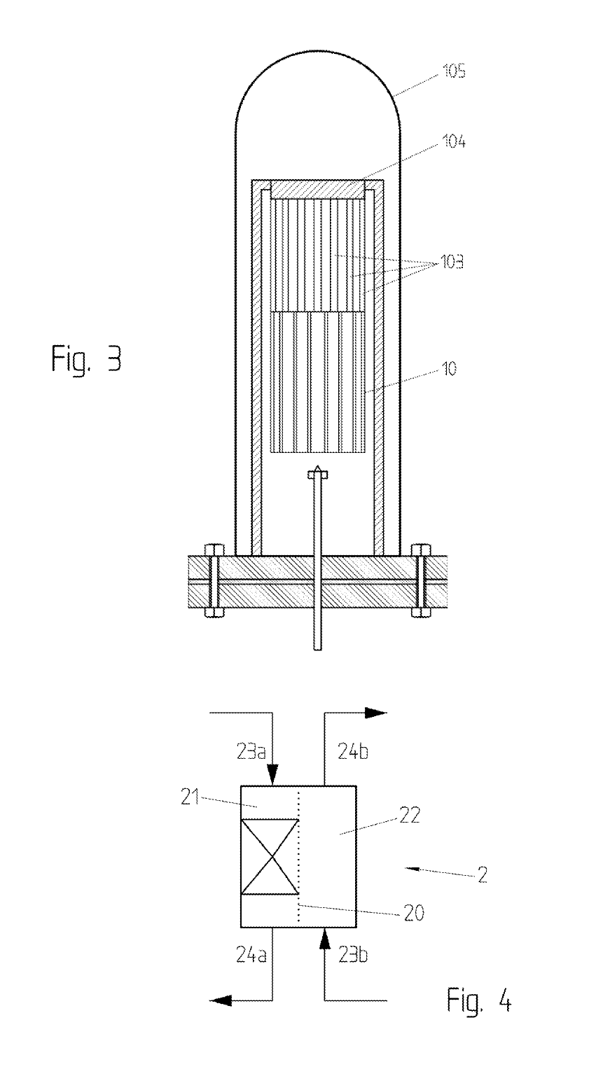

FIG. 3 shows the cold crucible in FIG. 2 with a part of the crucible cooling device,

FIG. 4 is a principle diagram of the catalytic membrane reactor according to the invention.

With reference to FIG. 1, the detritiation device according to one preferred version of the invention comprises a furnace 1 to melt the radioactive wastes, and a membrane reactor 2 to treat the tritiated gases derived from the melting and treatment of the wastes. For example, the furnace 1 is a cold crucible induction furnace described in more detail below, the cold crucible being located in the furnace 1 and being intended to receive the tritiated wastes to be treated, for example fusible metallic radioactive wastes. The temperature to be reached within the furnace is at least the melting temperature of the wastes to be detritiated, which is usually between 1000° C. and 1600° C.

One non-limitative embodiment of the crucible 10 is shown in FIG. 2, in which the crucible 10 is made from a magnetic material and segmented to minimize the currents induced in the crucible 10 at the time of heating the furnace 1.

For example, according to this embodiment, the crucible 10 is a segmented cylindrical copper crucible. The segments 100 are at a slight spacing from each other over the majority of their periphery, and are connected together for example only around the center of the bottom of the crucible 10. The division of the crucible 10 into different segments 100 at a spacing from each other can minimize, or even completely prevent, formation of induced currents in the crucible material when the induction furnace is activated, thus preventing undesirable heating of the crucible 10.

However other materials and/or forms can be envisaged in the framework of the invention for the crucible of the induction furnace. For example, according to one alternative embodiment, the crucible is formed in a single non segmented piece of a non-magnetic material.

The crucible 10 preferably comprises a nozzle 102, for example in its bottom, for introducing a hydrogenated bubbling gas into the crucible 10 and consequently in the mass of the molten wastes during its treatment. The nozzle 102 is connected through a conduit not shown to a source not shown of hydrogenated bubbling gas, for example to a gas reservoir preferably located outside the furnace.

The hydrogenated bubbling gas is composed of a chemically inert gas (for example, argon, helium . . . ) to which hydrogen (H₂) is added. For example, the composition by volume is Ar+1 to 10% of H₂, preferably Ar+2 to 4% of H₂.

According to one alternative embodiment, the crucible comprises several hydrogenated bubbling gas inlet nozzles to achieve a uniform distribution of the hydrogenated bubbling gas in the mass of the wastes in fusion. According to one variant of the invention, the hydrogenated bubbling gas is introduced into the mass of the wastes in fusion through one or several tubes introduced into the crucible 10 through its upper opening and immersed in the mass of the wastes in fusion.

For example, the crucible 10 is a cold crucible, that is the detritiation device further comprises a cooling device to cool the crucible 10. Consequently, the crucible 10 is actively kept by means of a cooling device, at a temperature significantly lower than the temperature of the wastes in fusion that it contains. This in particular enables the structural integrity of the cold crucible to be best protected at the time the furnace is heated during which a temperature that can reach between 1000° C. and 1600° C. can be reached.

The cold crucible also enables a reduction in the contamination of the crucible by the tritiated wastes, an easier removal from the mold after melting of the treated wastes, and a better control over tritium flows by reducing any losses other than through the planned outlets.

For example, the cooling device to cool the crucible 10 comprises channels 101 formed in the walls of the crucible 10 and through which a heat transfer fluid, for example a gas or a cooling liquid, can circulate inside the walls of the crucible 10. As shown in FIG. 2, each segment 100 is preferably 5 cooled individually and thus comprises for example a channel 101 for circulation of the heat transfer fluid.

With reference to FIG. 3, the cooling channels inside the walls of the crucible 10 are in communication with conduits 103 for the introduction of the heat transfer fluid in the channels. The conduits 103 are themselves supplied with a heat transfer fluid through a distributor 104 that distributes the cold heat transfer fluid between the conduits 103 and evacuates the hot heat transfer fluid, for example to a heat exchanger not shown preferably located outside the furnace, to cool it. Other configurations of the cooling device for cooling the crucible 10 are also possible within the framework of the invention.

The crucible 10 is preferably capped by a thermally insulating device not shown, and for example confined in a quartz glove finger 105 through which a vector gas can be introduced.

According to one preferred embodiment of the invention shown diagrammatically in FIG. 4, the catalytic membrane reactor 2 of the detritiation device is a four-pole component, in other words it comprises two inlets 23a, 23b and two outlets 24a, 24b, thus allowing the circulation of the two material flows within it. The membrane reactor 2 comprises two chambers 21, 22 each enabling circulation of a material flow through the reactor 2. The two chambers 21, 22 are separated by a membrane 20 that is preferably permeable to isotopes of hydrogen. The membrane 20 is preferably made from a palladium and silver alloy (Pd/Ag) that in particular catalyzes the isotopic exchange.

A first chamber 21 of the membrane reactor is integrated into a circuit A, B, C, D, E shown diagrammatically in FIG. 1, that also passes through the furnace 1 and that preferably comprises a pump 3 for circulation of the gas mix in the circuit A, B, C, D, E. The second chamber 22 is connected through the outlet 24b to a tritium recovery and/or storage system.

The detritiation process according to the invention is for example a batch type process comprising a series of sequences that is repeated for each batch of treated tritiated wastes.

During a start up sequence, the tritiated wastes are loaded into the furnace 1 of the detritiation device that is shown by arrow 6 in FIG. 1 and are placed in the cold crucible not shown in FIG. 1.

A vector gas is introduced into the circuit A, B, C, D, E, as shown by arrows 7 and 8. It may be hydrogenated and comprises a chemically inert gas (for example argon, helium . . . ) and preferably less than 4% (typically between 0.1% and 4%) by volume of hydrogen H₂. The vector gas for example is brought in from cylinders not shown fitted with pressure reducers and valves. The flow of the vector gas can vary as a function of quantities and activity of the tritiated wastes and capabilities of the system for trapping tritiated gases downstream.

The startup sequence is followed by a melting and detritiation sequence during which the furnace 1 is heated so as to melt the batch of tritiated wastes. According to one embodiment, the furnace 1 is an induction furnace and the wastes are metallic tritiated wastes that heat and melt under the effect of the magnetic field generated in the furnace 1.

The crucible in which the mass of molten or melting wastes are located is then for example kept at a temperature substantially lower than the temperature of the melting material by means of the cooling device. The use of a cold crucible facilitates removal of the ingot obtained after melting.

Once the wastes have been melted, a hydrogenated bubbling gas is introduced into the melting material, for example through the nozzle 102 located at the bottom of the crucible 10. The hydrogenated bubbling gas then passes through the melting material and an isotopic exchange takes place between the gas and the molten wastes, such that the gas phase is enriched in tritium.

Bubbling in the lower part has several advantages, for example the design is optimized for better gas distribution and therefore the detritiation factor is improved, and the gas produced by detritiation can be confined as much as possible.

The vector gas in circuit A, B, C, D, E is made to circulate in the detritiation device between the furnace 1 and the catalytic membrane reactor 2, for example using the pump 3 thus entraining tritiated gases from the furnace 1 to the membrane reactor 2.

The flow of tritiated gases from furnace 1 enters into the first chamber 21 through the inlet 23a of the membrane reactor 2, whereas a hydrogen flow H₂ is introduced in the opposite direction through the inlet 23b of the second chamber 22.

The tritiated gases are usually composed of a mix of gases with general formula Q₂ or Q₂O comprising tritium and at least one of the hydrogen isotopes denoted “Q” (where Q is either H=Hydrogen, D=Deuterium or T=Tritium), for example a gas chosen from among T₂, HT, DT, T₂O, HTO or DTO.

The tritiated gases are mixed with the vector gas when they reach the membrane 2.

Since the membrane that separates the flows is permeable to Q₂ but not Q₂O, the following isotopic exchange between the two flows takes place for example according to the following general formula:

H₂+Q₂O [symbol] H₂O+Q₂;

namely for example: H₂+T₂O [symbol] H₂O+T₂,

or H₂+HTO [symbol] H₂O+HT

Thus, the gas output from the first chamber 21 through the outlet 24a and returning to the furnace 1 via the pump 3 is essentially detritiated and comprises mainly the vector gas and water vapor. Hydrogen isotopes are recovered at the outlet 24b from the second chamber 22 of the membrane reactor 2, in the form of a gas mix (reduced species such as for example H₂, HT and/or T₂) which for example is stored directly in the form of hydrides or sent to a purification system.

During the melting and detritiation sequence, the pressure inside the detritiation device of the invention is preferably tested continuously or at regular intervals using a manometer not shown. The pressure is preferably kept at a constant value and is corrected if necessary by the addition of hydrogenated vector gas. The concentration of hydrogen in the hydrogenated bubbling gas is also measured and is regulated by the addition of hydrogen to optimize the isotopic exchange with the melting material and thus guarantee efficient detritiation of the wastes.

Once the batch of wastes has been treated, the power input to the detritiation device and particularly the furnace 1 is gradually reduced during a shutdown sequence. The circuit A, B, C, D, E is drained through an outlet 9 diagrammatically shown in FIG. 1. The detritiated metallic wastes are then discharged from furnace 1 for storage, elimination or recycling.

Example application of the detritiation process according to one embodiment of the invention:

### 1. Start Up

The following operations are identified during the start up phase:
Load tritiated wastes into the furnace, for example about 100 g, close the furnace and check that the device is well sealed;
Scavenge using a vector gas containing for example less than 4% by volume of hydrogen, or more if it is demonstrated that the process is safe. The flow may vary depending on quantities and activity of the tritiated waste, and the capabilities of the system for trapping tritiated gases downstream;
Apply power to the heating system until the metal goes into fusion, the power depending on the quantity of wastes, the type of metal, the scavenging flow and the efficiency of the furnace.

### 2. Melting and Detritiation

The following operations are identified during the detritiation operation:
Maintain scavenging of gas keeping bubbling in the molten metal;
Check the pressure and keep the hydrogen concentration constant in the hydrogenated bubbling gas, for example less than 4% by volume or more if it is demonstrated that the process is safe;
Collect bubbling gases and direct these gases into the membrane reactor, circulation in the tube(s) of this reactor;
Scavenge with hydrogen on the shell side of the membrane reactor in order to promote isotopic exchange;
Recover hydrogen isotopes that have diffused through the membrane;
The duration of the treatment is variable depending on the tritium activity, the nature of the material and the mass of the sample.

### 3. Shutdown

The following operations are identified during the shutdown phase:
Gradual reduction in the power input to the system, particularly to the heating system;
Drain through the outlet at the end of treatment;
Unload the detritiated waste once the temperature allowing the solidified waste to be manipulated is reached.

The above description shows that the detritiation device and process according to the invention have in particular at least one of the following advantages:
lower or even zero production of tritiated water,
immediate recovering of the tritium contained in the wastes,
improved detritiation efficiency: the ratio between the initial tritium content and the final tritium content can be between 1000 and more than 10000, depending on the nature of the materials and the initial activity.

1. Detritiation device comprising:
i) a furnace (1) for melting tritiated wastes comprising:
a crucible (10) for receiving the tritiated wastes;
a bubbling device for introducing a hydrogenated bubbling gas into said crucible (10) during the melting and treatment of the tritiated wastes in said furnace (1); and
ii) a catalytic four-pole membrane reactor (2) for the treatment of the gases originating from the melting and treatment of the tritiated wastes in said furnace (1), comprising a membrane (20) to separate two gas flows, said membrane (20) being permeable to isotopes of hydrogen.

2. Detritiation device according to the previous claim, said membrane (2) being made from a palladium and silver alloy.

3. Detritiation device according to claim 1, said furnace (1) being an induction furnace.

4. Detritiation device according to claim 3, said crucible (10) being made from a magnetic material and segmented to minimize the currents induced in said crucible (10) at the time of heating the furnace (1).

5. Detritiation device according to claim 1, further comprising a cooling device to cool said crucible (10).

6. Detritiation device according to claim 1, said bubbling device comprising a nozzle (102) in the bottom of said crucible (10) for introducing the hydrogenated bubbling gas into said crucible (10).

7. Detritiation device according to claim 1, further comprising a pump (3) for circulation of a vector gas in said detritiation device between said furnace (1) and said catalytic membrane reactor (2).

8. Detritiation process comprising the steps of:
loading a crucible (10) furnace (1) with a batch of tritiated wastes;
heating the furnace (1) to melt the tritiated wastes in said crucible (10);
bubbling the melting tritiated wastes by introducing a hydrogenated bubbling gas into said crucible (10); and
circulating a vector gas between said furnace (1) and a catalytic membrane reactor (2) for entrainment of the tritiated gases produced during the melting and treatment of the tritiated wastes, and the treatment of the tritiated gases that comprises an isotopic exchange through the membrane (20) of said catalytic membrane reactor (2).

9. Process according to claim 8, further comprising introducing a hydrogen H₂ flow in the direction opposite to the tritiated gases flow in said catalytic membrane reactor (2) and recovering tritium in the gas phase.

10. Process according to claim 8, further comprising discharging of the batch of wastes treated outside the furnace (1).

11. Process according to claim 8, comprising a catalytic four-pole membrane reactor (2).
